(19) United States
(12) Patent Application Publication
(10) Pub. No.: US 2016/0283605 A1
(43) Pub. Date: Sep. 29, 2016

(54) INFORMATION EXTRACTION DEVICE, INFORMATION EXTRACTION METHOD, AND DISPLAY CONTROL SYSTEM

(71) Applicant: NEC Corporation, Tokyo (JP)

(72) Inventor: NOBUTATSU NAKAMURA, Tokyo (JP)

(73) Assignee: NEC Corporation

(21) Appl. No.: 15/058,333

(22) Filed: Mar. 2, 2016

(30) Foreign Application Priority Data
Mar. 24, 2015 (JP) 2015-060288

(51) Int. Cl. G06F 17/30; G06F 17/22

(52) U.S. Cl. CPC G06F 17/30896; G06F 17/30887; G06F 17/30011; G06F 17/2247

(57) ABSTRACT

An information extraction device includes: a storage unit that stores structured model information that is a result obtained by learning a relationship between a type of structured information that is information having a relationship and a data content or a position of data of the structured information; and a structurization executing unit that extracts the structured information from document data that is an extraction object based on the structured model information.

This application is based upon and claims the benefit of priority from Japanese Patent Application No. 2015-060288, filed on Mar. 24, 2015, the disclosure of which is incorporated herein in its entirety by reference.

### TECHNICAL FIELD

The present invention relates to an information extraction device, an information extraction method, and a display control system.

### BACKGROUND ART

For example, there are many cases in which when a job seeker looks for opportunities for employment with companies, the job seeker cannot get sufficient information from the recruitment information given by the company. Further, there are many cases in which although the company potentially faces a labor shortage, the company does not provide job posting information because the cost of creating the job advertisement is high. In such case, generally, the job seeker has to search for a Web page of the company, advertisement, or information of publication in order to get the information.

Further, for example, when the company commercializes a new product, the company collects information about competitor's movement and performs an analysis in order to make a company's strategic plan. When the company collects the information about competitor's movement, the company has to collect a list of functions of the competitor's product, information about the price of the product, and information about sales, grasp a change in tendency or the like on the basis of the sales data in chronological order, and recognize a trend of function development.

Thus, a case in which organized information (structured information) having a relationship has to be extracted from web information occurs.

In Japanese Patent Application Laid-Open No. 2014-049088, a technology in which a part to be extracted from a Web page can be extracted by clustering a plurality of elements in a document of which the Web page is composed is disclosed. In Japanese Patent Publication No. 5020414, a technology in which a search condition is entered in a search engine on the Web and company data on the Internet is extracted by using a result of the search is disclosed.

In Japanese Patent Publication No. 5125161, a technology in which company information or the like is extracted from Web information on the basis of a rule set in advance such as a rule in which information including the keyword created in advance is searched for and extracted or the like is disclosed.

In Japanese Patent Application Laid-Open No. 2006-227925, a technology related to an information providing server which can collect topical information that is talked-about and comment information from a Web site which exists on the Internet and provide information obtained by aggregating the collected information is disclosed.

By the way, the technology disclosed in Japanese Patent Application Laid-Open No. 2014-049088 can be used in only case in which in analyzing a hierarchical structure of the HTML (Hyper Text Markup Language), an object of the analysis is data that can have the hierarchical structure.

Further, in the technology disclosed in Japanese Patent Publication No. 5020414, it is premised that the indexing of company data is performed and it is searched for by a search engine. For this reason, when a synonym is not defined in advance, it is necessary to individually perform a search and manually integrate the searched results. Therefore, it takes a lot of man-hours.

Further, in the technology disclosed in Japanese Patent Publication No. 5125161, it is premised that an information provider discloses the data in an RSS (Rich Site Summary).

Further, the technology disclosed in Japanese Patent Application Laid-Open No. 2006-227925 is a technology which selects a sentence itself that is an article of the Web site, when it collects similar and related information, and not a technology which extracts the data from the sentence.

In the case example described in the above technologies, a rule has to be manually set in order to extract the desired data from the Web data. For example, the Web site from which the data is obtained and a method for converting the data into the structured information depend on the worker's know-how or the like.

### SUMMARY

For this reason, an object of the present invention is to solve the above-mentioned problem and efficiently extract the structured information from the Web site.

An information extraction device according to an exemplary aspect of the invention includes, a storage unit that stores structured model information that is a result obtained by learning a relationship between a type of structured information that is information having a relationship and a data content or a position of data of the structured information; and a structurization executing unit that extracts the structured information from document data that is an extraction object based on the structured model information.

An information extraction method according to an exemplary aspect of the invention includes, storing structured model information that is a result obtained by learning a relationship between a type of structured information that is information having a relationship and a data content or a position of data of the structured information; and extracting the structured information from document data that is an extraction object on the basis of the structured model information.

A display control system according to an exemplary aspect of the invention includes, a structurization executing unit that extracts structured information that is information having a relationship from document data that is an extraction object; and a display control unit that makes a terminal display an extraction result in order of a certainty of result obtained by extracting the structured information.

### BRIEF DESCRIPTION OF THE DRAWINGS

Exemplary features and advantages of the present invention will become apparent from the following detailed description when taken with the accompanying drawings in which:

FIG. 1 is a block diagram showing an example of a configuration of an information extraction device according to a first exemplary embodiment of the present invention,

FIG. 2 is a block diagram showing a hardware circuit in which the information extraction device is realized by using an information processing device,

FIG. 3 is a flowchart showing operation of the information extraction device,

FIG. 4 is a figure showing an example of description of Web data,

FIG. 5 is a figure showing an example of teacher data,

FIG. 6 is a figure showing another example of the teacher data,

FIG. 7 is a figure showing an example of structured model information,

FIG. 8 is a figure showing an example of structured information that is an extraction result,

FIG. 9 is a block diagram showing an example of a configuration of an information extraction device according to a second exemplary embodiment,

FIG. 10 is a flowchart showing operation of the information extraction device according to the second exemplary embodiment,

FIG. 11 is a block diagram showing an example of a configuration of an information extraction device according to a third exemplary embodiment,

FIG. 12 is a flowchart showing operation of the information extraction device according to the third exemplary embodiment,

FIG. 13 is a block diagram showing an example of a configuration of an information extraction device according to a fourth exemplary embodiment,

FIG. 14 is a flowchart showing operation of the information extraction device according to the fourth exemplary embodiment,

FIG. 15 is another flowchart showing operation of the information extraction device according to the fourth exemplary embodiment,

FIG. 16 is a block diagram showing an example of a configuration of a display control system according to a fifth exemplary embodiment,

FIG. 17 is a figure showing an example of information displayed in a terminal according to the fifth exemplary embodiment, and

FIG. 18 is a block diagram showing an example of a configuration of an information extraction device according to a sixth exemplary embodiment.

### EXEMPLARY EMBODIMENT

A first exemplary embodiment for practicing the invention will be described in detail with reference to a drawing.

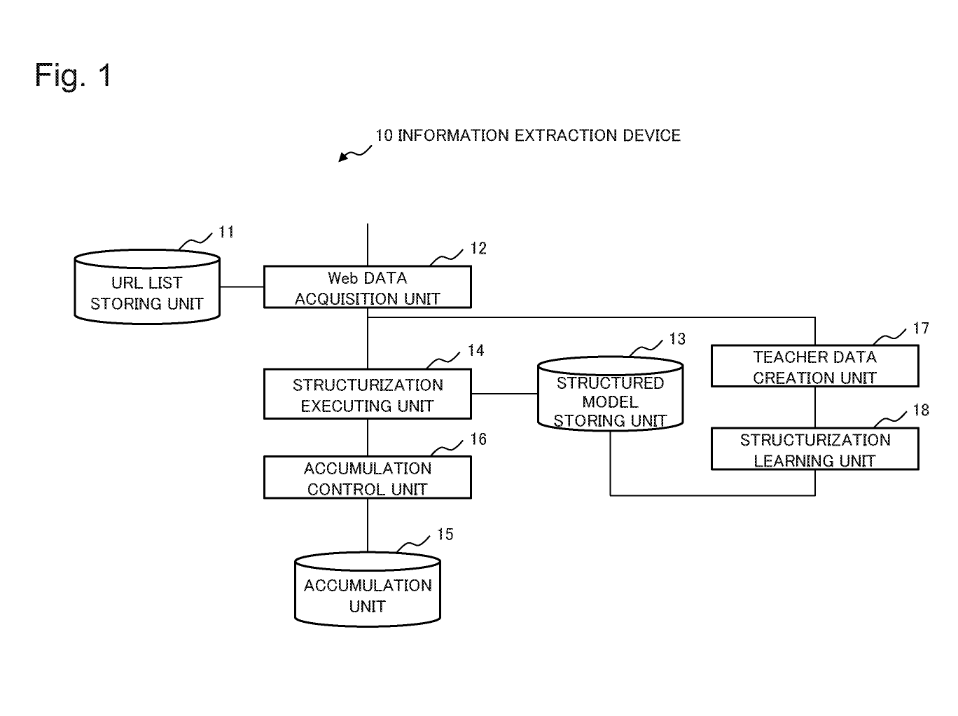

FIG. 1 is a block diagram showing an example of a configuration of an information extraction device 10 according to the first exemplary embodiment of the present invention.

The information extraction device 10 is composed of a URL (Uniform Resource Locator) list holding unit 11, a Web data acquisition unit 12, a structured model holding unit 13, a structurization executing unit 14, an accumulation unit 15, an accumulation control unit 16, a teacher data creation unit 17, and a structurization learning unit 18. This exemplary embodiment of the present invention can extract organized information (structured information) having a relationship desired by a user from document data including unstructured information such as the Web data by performing learning.

The URL list storing unit 11 stores a list of the URLs of the Web sites that are data acquisition sources.

The Web data acquisition unit 12 accesses the Web site by using the URL list stored in the URL list storing unit 11 and acquires(reads) the Web data.

The structured model storing unit 13 stores information required for extracting information (hereinafter, it is referred to as structured information because it is also structured information) desired by the user from the Web data that is an extraction object acquired by the Web data acquisition unit 12. Specifically, the structured model storing unit 13 stores structured model information that is a result obtained by performing learning of a relation (teacher data) between a type of the structured information and a displayed content or a display position of the structured information in the Web screen (hereinafter, referred to as “displayed content” and “display position”) on the basis of the Web data that is an object to be learned and acquired in advance. Further, the displayed content is also called data content and the display position is also called a position of data. The teacher data that is a learning object corresponds to a pair of the type of the structured information and the displayed content and a pair of the type of the structured information and the display position.

The structurization executing unit 14 extracts the structured information that is the information desired by the user from the Web data that is the extraction object acquired by the Web data acquisition unit 12 on the basis of the structured model information stored in the structured model storing unit 13.

The accumulation unit 15 stores the structured information extracted by the structurization executing unit 14.

The accumulation control unit 16 stores the structured information extracted by the structurization executing unit 14 in the accumulation unit 15.

The teacher data creation unit 17 creates the teacher data indicating the relationship between the type of the information desired by the user and the displayed content or the display position on the basis of the Web data that is an object to be learned and acquired by the Web data acquisition unit 12.

The structurization learning unit 18 reads the teacher data created by the teacher data creation unit 17, for example, a plurality of pairs of the type of the information desired by the user and the displayed content or the display position and learns the relationship between the type of the structured information and the displayed content or the display position of the structured information. Further, the structurization learning unit 18 creates the structured model information that is a result obtained by performing learning and stores it in the structured model storing unit 13.

As described above, the teacher data creation unit 17 of the information extraction device 10 focuses on a plurality of combinations of open information such as the Web page presented on the Internet or the like and the displayed content or the display position of the item in the open information. When a plurality of the combinations are detected, the structurization learning unit 18 performs modeling (creates the structured model information) by using information indicating a position (display position) at which information (displayed content) corresponding to the certain item related to the type of the structured information is displayed in the open information by performing machine learning. The structurization executing unit 14 extracts the information desired by the user from the Web page that is the extraction object on the basis of the structured model information.

For example, in a sentence for publicity about a new product in the Web page that is the extraction object, a format of “”seller's name” starts to sell a “product name” from “sale date”” is usually used. For this reason, the information extraction device 10 stores this format in the structured model storing unit 13 as the structured model information. In this case, the structurization executing unit 14 applies the format to the Web page that is the object and extracts the information of the “seller's name”, the “sale date”, and the “product name” from the sentence for publicity about the new product in the Web page as the structured information.

In the information extraction device 10, each of the Web data acquisition unit 12, the structurization executing unit 14, the accumulation control unit 16, the teacher data creation unit 17, and the structurization learning unit 18 is composed of hardware such as a logic circuit or the like.

Further, each of the Web data acquisition unit 12, the structurization executing unit 14, the accumulation control unit 16, the teacher data creation unit 17, and the structurization learning unit 18 may be a functional unit realized by executing a program on a memory (not shown) by a processor of the information extraction device 10 that is a computer.

Each of the URL list storing unit 11, the structured model storing unit 13, and the accumulation unit 15 is composed of a storage device such as a disk device, a semiconductor memory, or the like.

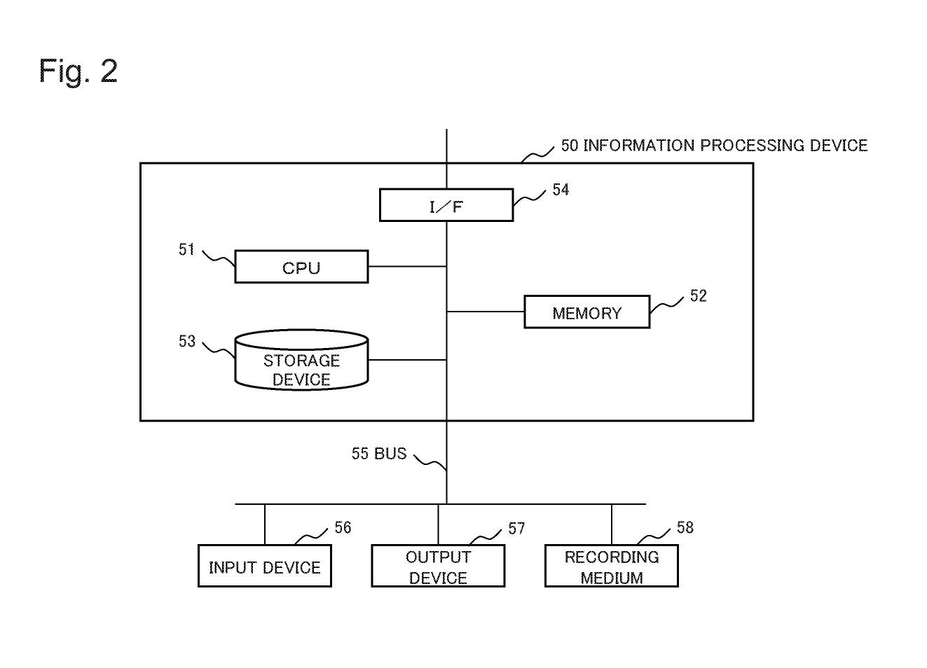

FIG. 2 is a block diagram showing an example of a hardware circuit in which the information extraction device 10 is realized by an information processing device 50 that is a computer.

As shown in FIG. 2, the information processing device 50 includes a CPU (Central Processor Unit) 51, a memory 52, a storage device 53 such as a hard disk storing a program, and an I/F (Interface) 54 for network connection. Further, a computer device 50 is connected to an input device 56 and an output device 57 via a bus 55.

The CPU 51 operates the operating system and controls the whole information processing device 50. Further, for example, the CPU 51 may read the program and the data from a recording medium 58 installed in a drive device or the like and store them in the memory 52. Further, the CPU 51 functions as the Web data acquisition unit 12, the structurization executing unit 14, the accumulation control unit 16, the teacher data creation unit 17, and a part of the structurization learning unit 18 in the information extraction device 10 shown in FIG. 1 and executes various processes on the basis of the program. The CPU 51 may be composed of a plurality of CPUs.

For example, the storage device 53 is composed of an optical disk drive, a flexible disk drive, a magneto-optical disk drive, an external hard disk drive, a semiconductor memory device, or the like and is controlled by the CPU 51. The storage device 53 is a storage medium which functions as the URL list holding unit 11, the structured model holding unit 13, and the accumulation unit 15. The storage medium 58 is a non-volatile storage device and memorizes the program executed by the CPU 51. The storage medium 58 may be a part of the storage device 53. Further, the program may be downloaded from an external computer (not shown) connected to a communication network via the I/F 54. The storage device 53 and the memory 52 may operate as a shared memory.

For example, a mouse, a keyboard, a built-in key button, or the like is used for the input device 56 and the input device 56 is used for an input operation. The input device 56 is not limited to a mouse, a keyboard, or a built-in key button and may be a touch panel. The output device 57 is for example, a display and used for confirming an output.

As described above, the information processing device 50 corresponding to the information extraction device 10 according to the first exemplary embodiment shown in FIG. 1 may have a hardware configuration shown in FIG. 2. However, the configuration of the information processing device 50 is not limited to the configuration shown in FIG. 2. For example, the input device 56 and the output device 57 may be provided outside of the information processing device 50 and connected to the information processing device 50 via the interface 54.

The information processing device 50 may be one physically combined device or realized by using two or more physically separate devices connected to each other by wire or wireless.

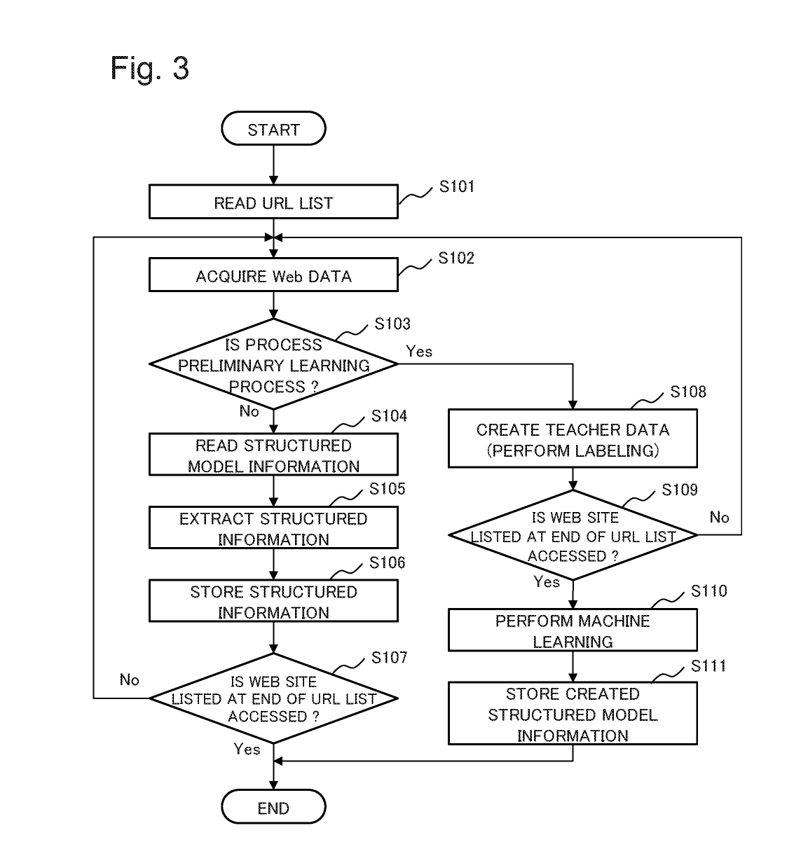

FIG. 3 is a flowchart showing operation of the information extraction device 10.

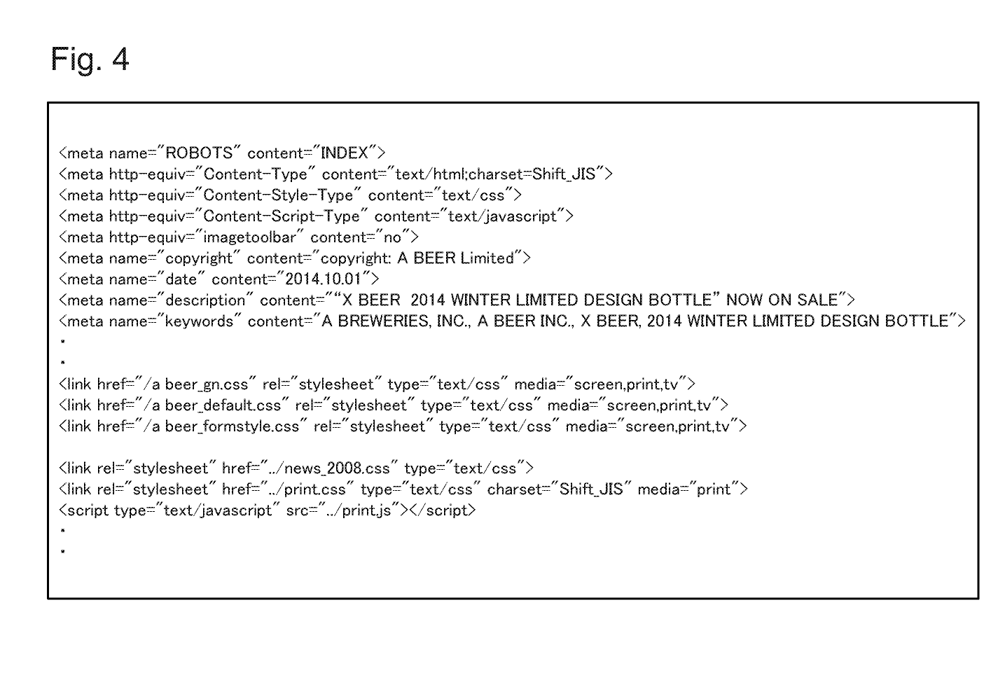

First, the Web data acquisition unit 12 reads the URL list from the URL list storing unit 11 (step S101). The Web data acquisition unit 12 accesses the Web site by using the URL list and acquires the Web data (described later with reference to FIG. 4) (step S102).

If the process performed by the information extraction device 10 is a preliminary learning process (Yes in step S103), the process proceeds to step S108 and the information extraction device 10 performs the process in step S108.

On the other hand, when the process performed by the information extraction device 10 is a structurization process of the acquired Web data (No in step S103), the process proceeds to step S104 and the information extraction device 10 performs the process in step S104. Further, this decision is specified by the user by using an argument of the program or the like or automatically made by the CPU 51 according to the state of the information extraction device 10.

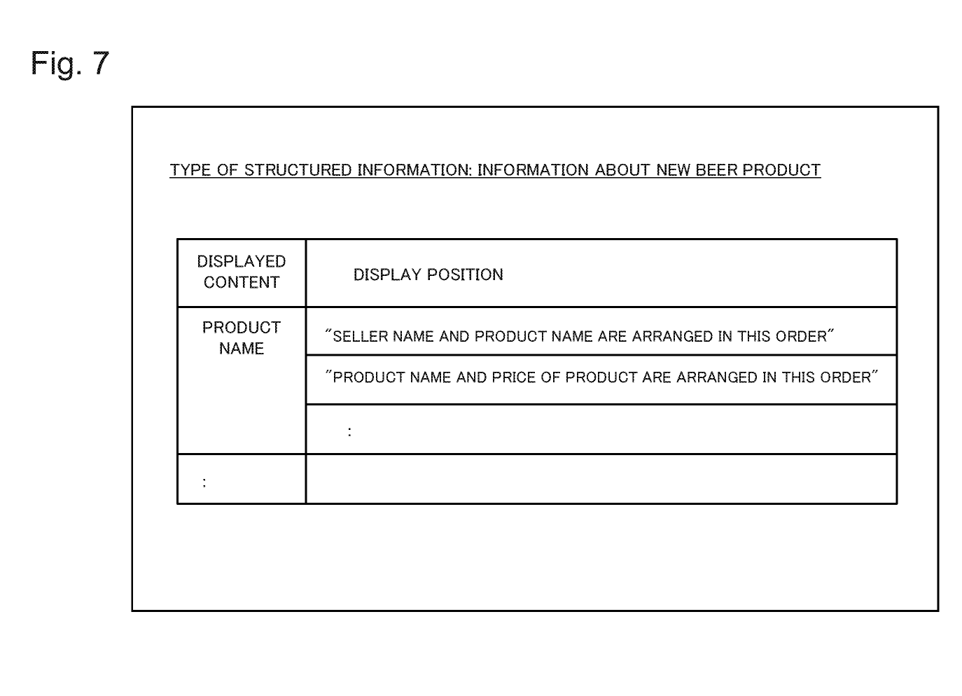

When the structurization process is performed, the structurization executing unit 14 reads the structured model information created in advance (described later with reference to FIG. 7) used for extracting the information desired by the user from the structured model storing unit 13 (step S104). Further, when it has already been read, it is not necessary to read it again.

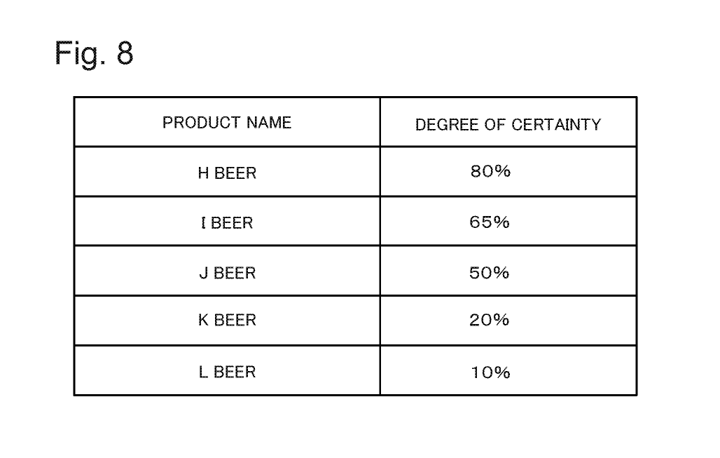

Next, the structurization executing unit 14 extracts the information desired by the user (described later with reference to FIG. 8) from the Web data acquired by the Web data acquisition unit 12 in step S102 on the basis of the structured model information (step S105). The accumulation control unit 16 stores the information extracted by the structurization executing unit 14 in step S105 in the accumulation unit 15 (step S106).

The Web data acquisition unit 12 accesses the Web sites listed in the URL list in series. When the Web site listed at the end of the URL list is accessed, the process ends (Yes in step S107). When the access is performed to the Web site that is not the Web site listed at the end of the URL list (No in step S107), the process goes back to step S102 and the Web data acquisition unit 12 accesses the subsequent Web site listed in the URL list that is not accessed.

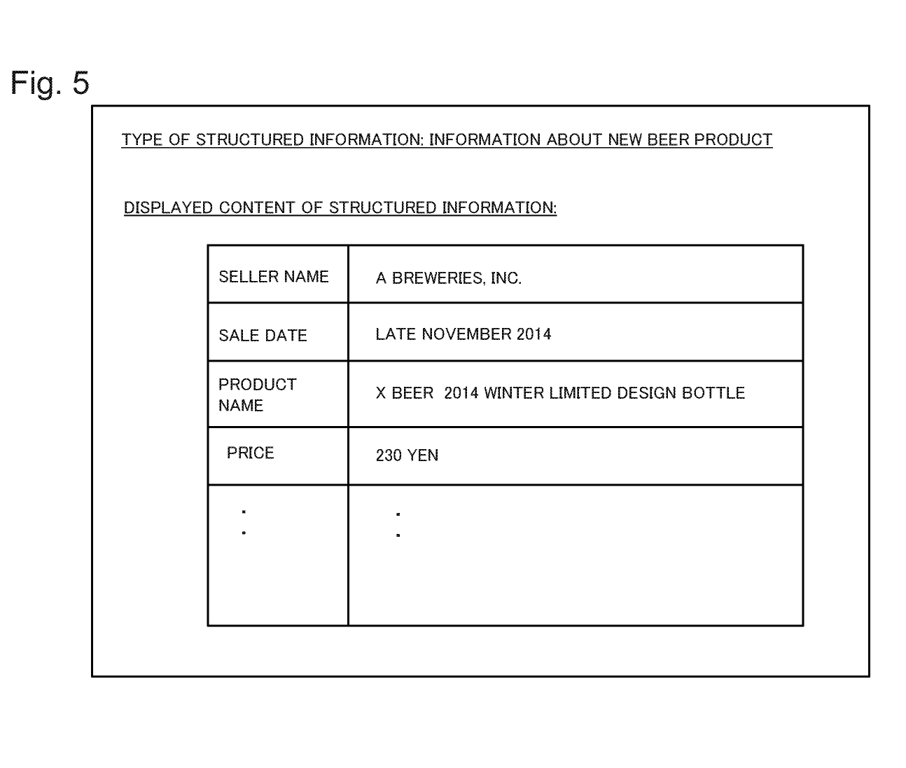

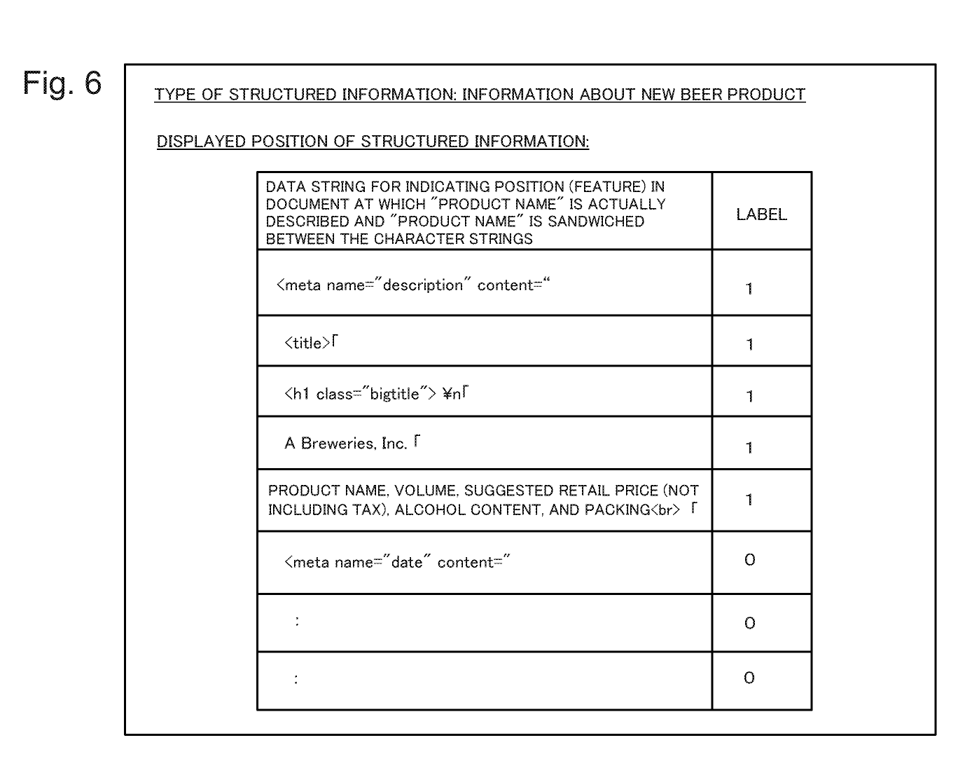

On the other hand, when the process is the preliminary learning process (Yes in step S103), the teacher data creation unit 17 creates the teacher data (described later with reference to FIG. 5 and FIG. 6) which indicates a correspondence relationship between the type of the information desired by the user and the displayed content or the display position (performs labeling of the data concerned) (step S108).

The Web data acquisition unit 12 accesses the Web sites listed in the URL list in series. When the Web site listed at the end of the URL list is accessed (Yes in step S109), the process proceeds to step S110. On the other hand, when the access is performed to the Web site that is not the Web site listed at the end of the URL list (No in step S109), the process goes back to step S102 and the Web data acquisition unit 12 performs the preliminary learning process to the subsequent Web site listed in the URL list that is not accessed.

When the decision result is Yes in step S109, the structurization learning unit 18 reads a plurality of pairs (teacher data) of the type of the information desired by the user and the displayed content or the display position and creates the structured model information used for extracting the information desired by the user from the Web data that is the learning object by performing machine learning (step S110). The structured model information is the modeled information indicating a position (display position) in the open information at which information (displayed content) that corresponds to a certain item related to the kind of the structured information in the Web data is displayed. The structurization learning unit 18 stores the created structured model information in the structured model storing unit 13 and ends the process (step S111).

FIG. 4 is a figure showing an example of description of the Web data. FIG. 4 shows an example of a description of the HTML (Hyper Text Markup Language) for showing the Web site that is the object to be learned. Further, in FIG. 4, a HTML character string is used for describing the Web data as an example.

However, the language for describing the Web data is not limited to the HTML and a character string and a language other than the HTML can be used. Although a display screen of the Web site in which the HTML is used exists, the description of the display screen will be omitted.

FIG. 5 and FIG. 6 are figures showing an example of the teacher data created by the teacher data creation unit 17.

FIG. 5 is a figure showing an example of the teacher data showing an example of a pair of the type of the structured information and the displayed content of the structured information. As shown in FIG. 5, the type of the structured information is “information about new beer product”. Further, the displayed content of the structured information includes the items of “seller's name”, “sale date”, “product name”, and “price” as an example. Further, in the displayed content, a specific content corresponding to each item is described in the right column.

By the way, in FIG. 5, “information about new beer product” is taken as an example of the type of the structured information. However, arbitrary information such as “information about product”, “information about new product”, “information about beer”, or the like can be set as the type of the structured information.

Further, in this exemplary embodiment, in the following explanation, it is assumed that the type of the structured information is “information about new beer product”.

FIG. 6 is a figure showing an example of the teacher data showing an example of a pair of the type of the structured information and the display position of the structured information.

In FIG. 6, data described in the left column of a table of the display position of the structured information is a data string for indicating a position (feature) in the document at which “product name” among the items shown in FIG. 5 is actually described and “product name” is sandwiched between the character strings (HTML character strings) described in the left column shown in FIG. 6.

In the display position of the structured information shown in FIG. 6, data described in the right column is a flag (also referred to as a label) indicating whether or not the HTML character strings described in the left column correspond to the character strings between which the position (feature) in the document at which “product name” is actually described is sandwiched. This confirmation is performed by the structurization learning unit 18. The label is “1” when the HTML character strings corresponds to the character strings, or “0” when the HTML character strings do not correspond to the character strings.

Further, although FIG. 5 and FIG. 6 show an example of the teacher data, the structurization learning unit 18 may perform learning on the basis of a plurality of the teacher data including the teacher data other than the teacher data shown in FIG. 5 and FIG. 6.

FIG. 7 is a figure showing an example of the structured model information held by the structured model holding unit 13. In FIG. 7, with respect to the displayed content of “product name”, a result obtained by performing learning of the display position shown in FIG. 6 is shown. For example, in FIG. 7, “Seller Name and Product Name are arranged in this order”, “Product Name and Price of Product are arranged in this order”, or the like is obtained as the result of learning.

FIG. 8 is a figure showing an example of the structured information (information desired by the user) that is the extraction result that is extracted by the structurization executing unit 14 and stored in the accumulation unit 15. In the extraction result shown in FIG. 8, with respect to “product name” among the items shown in FIG. 5, a candidate name of the structured information extracted by performing learning and a degree of certainty are displayed together.

For example, the structurization executing unit 14 calculates and outputs the degree of certainty indicating certainty of the result obtained by extracting the structured information by using a general machine learning algorithm such as libsvm (registered trademark) or the like. According to the result shown in FIG. 8, for example, the degree of certainty of “H beer” is 80% and “H beer” has the highest degree of certainty in the candidates.

Up to now, this data extraction work is performed by a person. However, as described above, the information extraction device 10 automatically collects the data on the basis of a work model (structured model information) that is the result of machine learning, converts the collected data into the structured information that is the organized information having a relationship, and accumulates it. As a result, when the information extraction device 10 is used, the process can be efficiently performed because the person does not need to manually set a rule and only needs to perform a simple operation of giving a case example.

The information extraction device 10 according to this exemplary embodiment has an effect described below.

Namely, the information extraction device 10 can efficiently extract the structured information from the Web site.

The reason is described below. Namely, the teacher data creation unit 17 creates the teacher data indicating the relationship between the type of the structured information having the relationship and the data content or the position of data of the structured information on the basis of the web data that is the learning object. Further, the structurization learning unit 18 learns the relationship between the type of the structured information and the data content or the position of data of the structured information on the basis of a plurality of the teacher data and creates the structured model information that is the result of learning. The structurization executing unit 14 extracts the structured information from the Web data that is the extraction object on the basis of the structured model information.

### Second Exemplary Embodiment

Next, a second exemplary embodiment for practicing the present invention will be described in detail with reference to the drawing.

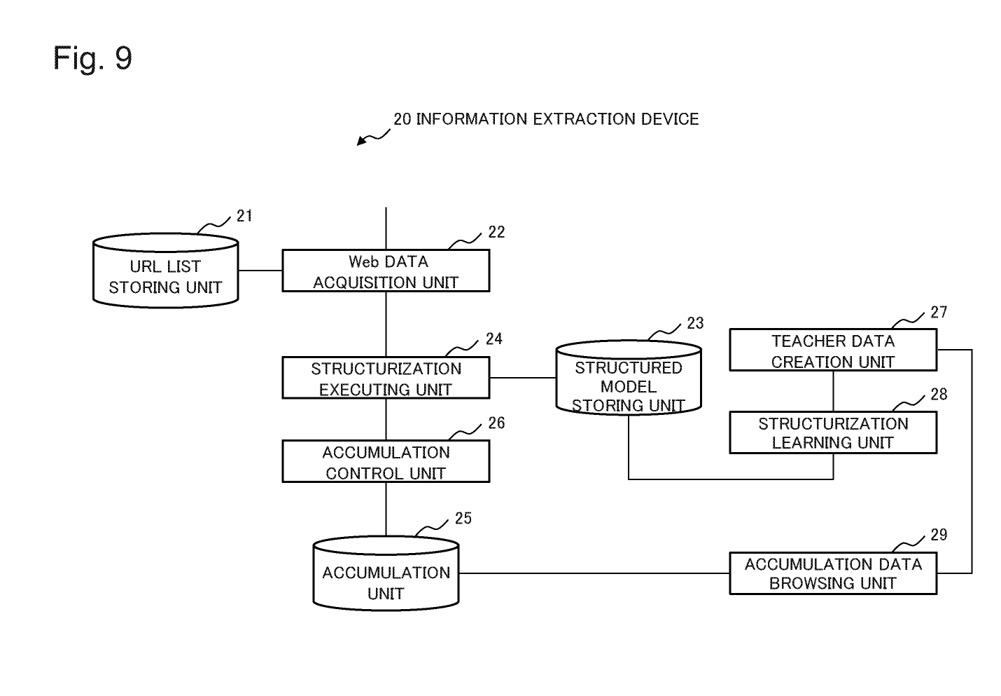

FIG. 9 is a block diagram showing an example of a configuration of an information extraction device 20 according to the second exemplary embodiment.

As shown in FIG. 9, the information extraction device 20 has a configuration in which an accumulation data browsing unit 29 is added to the information extraction device 10 according to the first exemplary embodiment and can create the structured information having higher precision.

Further, a URL list storing unit 21, a Web data acquisition unit 22, a structured model storing unit 23, a structurization executing unit 24, an accumulation unit 25, an accumulation control unit 26, a teacher data creation unit 27, and a structurization learning unit 28 are similar to the URL list storing unit 11, the Web data acquisition unit 12, the structured model storing unit 13, the structurization executing unit 14, the accumulation unit 15, the accumulation control unit 16, the teacher data creation unit 17, and the structurization learning unit 18, respectively and the description of the operation of each component will be omitted.

The accumulation data browsing unit 29 makes the structured information stored in the accumulation unit 25 that is the data of the extraction result viewable to the user. Further, when the combination of the structured information is incorrect, the accumulation data browsing unit 29 enables the user to correct it.

Further, the accumulation data browsing unit 29 sends new teacher data (corrected data) indicating a corrected correspondence relationship between the type of information and the displayed content or the display position of the information to the teacher data creation unit 27. The structurization learning unit 28 re-creates the structured model information on the basis of the information from the teacher data creation unit 27. The structurization learning unit 28 stores the re-created structured model information in the structured model storing unit 23.

Thus, the information extraction device 20 can create the structured information having higher precision by performing a structuriization process again by using the re-created structured model information.

Here, the accumulation data browsing unit 29 is composed of hardware such as a logic circuit or the like. The accumulation data browsing unit 29 may be realized by executing a program on a memory (not shown) by the processor of the information extraction device 20 that is a computer.

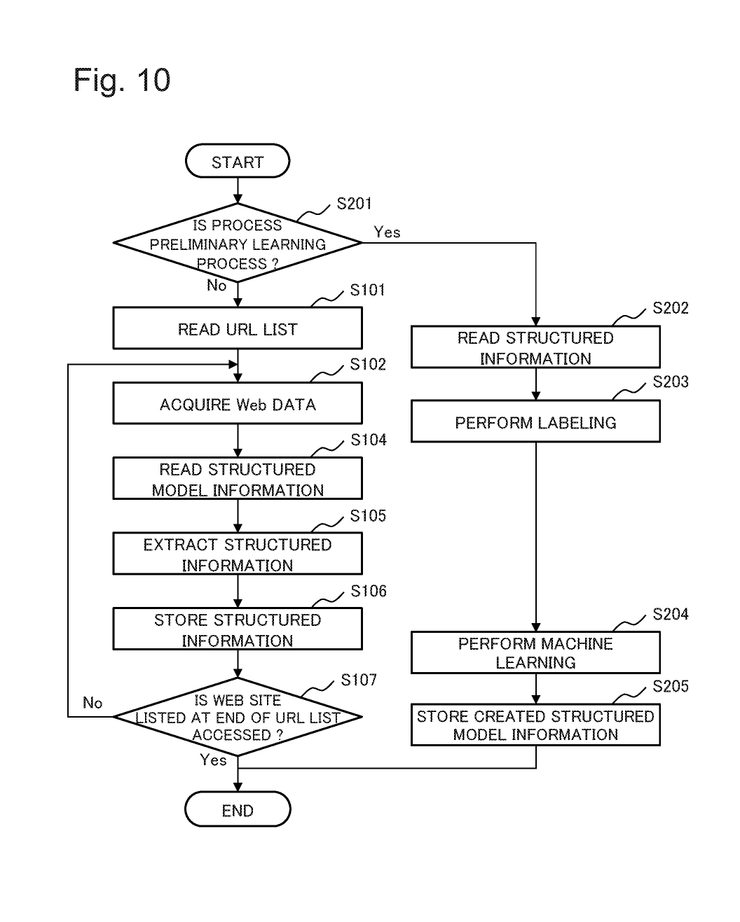

Next, the operation of the information extraction device 20 will be described by using FIG. 10. FIG. 10 is a flowchart showing the operation of the information extraction device 20.

Further, the process of step (S1xx) in FIG. 10 is the same as the process of (S1xx) in FIG. 3. Therefore, the detailed description of the process will be omitted.

First, when this process is the preliminary learning process (Yes in step S201), the process proceeds to step S202 and the information extraction device 20 performs the process in step S202. On the other hand, when it is the structurization process of the acquired Web data (No in step S201), the process proceeds to step S101 and the information extraction device 20 performs the process in step S101. Further, when the decision of step S201 is made, this decision may be specified by the user by using an argument or the like of the program or automatically made by the CPU 51 according to the state of the information extraction device 20.

The accumulation data browsing unit 29 reads the structured information stored in the accumulation unit 25 that is the extracted data and displays it so that the user can browse it (step S202). When the structured information includes an error, the teacher data creation unit 27 which receives a user's correction instruction from the accumulation data browsing unit 29 creates new teacher data (performs labeling as shown in FIG. 6) (step S203). Thus, by the instruction of the accumulation data browsing unit 29, the teacher data creation unit 27 creates the data indicating the correspondence relationship between the type of the corrected information and the displayed content or the display position.

Next, the structurization learning unit 28 re-creates the structured model information by performing machine learning by a process similar to the process of step S110 (step S204).

The structurization learning unit 28 stores the created structured model information in the structured model storing unit 23 and ends the process (step S205).

The information extraction device 20 according to this exemplary embodiment has an effect described below.

Namely, the information extraction device 20 can create the structured information having higher precision.

This is because the accumulation data browsing unit 29 can re-create the structured model information on the basis of the user's correction instruction.

### Third Exemplary Embodiment

Next, a third exemplary embodiment for practicing the present invention will be described in detail with reference to the drawing.

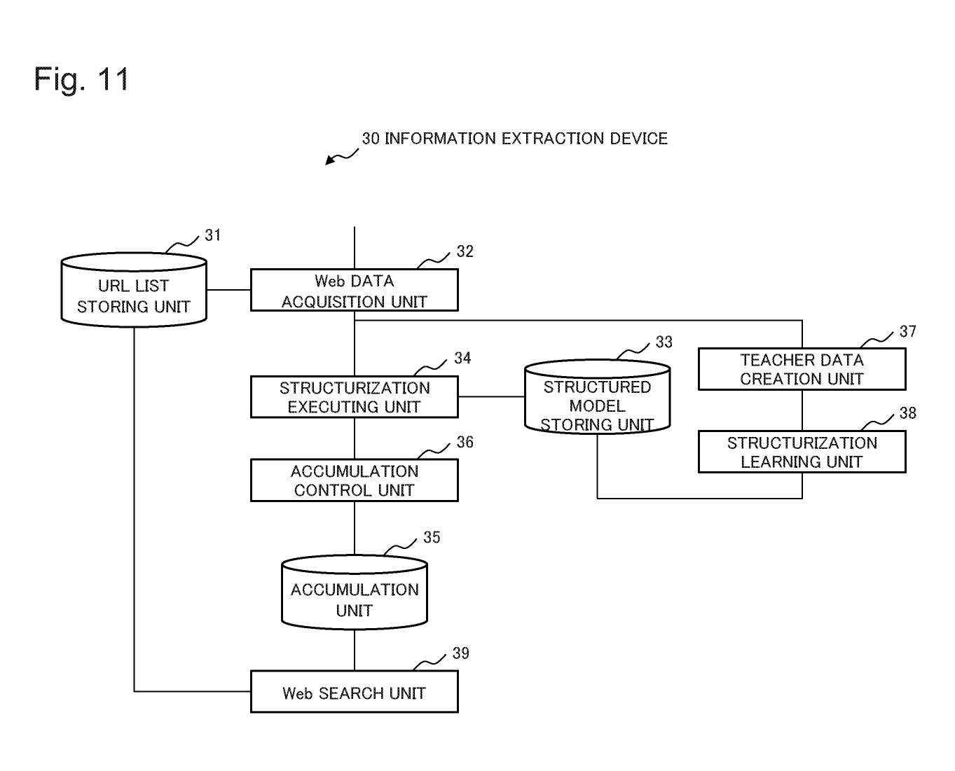

FIG. 11 is a block diagram showing an example of a configuration of an information extraction device 30 according to the third exemplary embodiment.

As shown in FIG. 11, the information extraction device 30 has a configuration in which a Web search unit 39 is added to the information extraction device 10 according to the first exemplary embodiment and can improve the URL list of the Web servers that are information acquisition sources.

Further, a URL list storing unit 31, a Web data acquisition unit 32, a structured model holding unit 33, a structurization executing unit 34, an accumulation unit 35, an accumulation control unit 36, a teacher data creation unit 37, and a structurization learning unit 38 are similar to the URL list storing unit 11, the Web data acquisition unit 12, the structured model storing unit 13, the structurization executing unit 14, the accumulation unit 15, the accumulation control unit 16, the teacher data creation unit 17, and the structurization learning unit 18, respectively and the description of the operation of each component will be omitted.

When the new combination exists among the combinations of the types of the structured information stored in the accumulation unit 35 that is the extracted data and the contents, the Web search unit 39 searches for the content on the Internet when the content is correct information. The Web search unit 39 creates a list of the Web pages including this content. When a new URL is included in the list, the Web search unit 39 updates the list held by the URL list holding unit 31.

As a result, the information extraction device 30 can increase the number of URLs of the Web servers that are information sources for new information and can extract a wide range of data.

Here, the Web search unit 39 is composed of hardware such as a logic circuit or the like. The Web search unit 39 may be realized by executing a program on a memory (not shown) by the processor of the information extraction device 30 that is a computer.

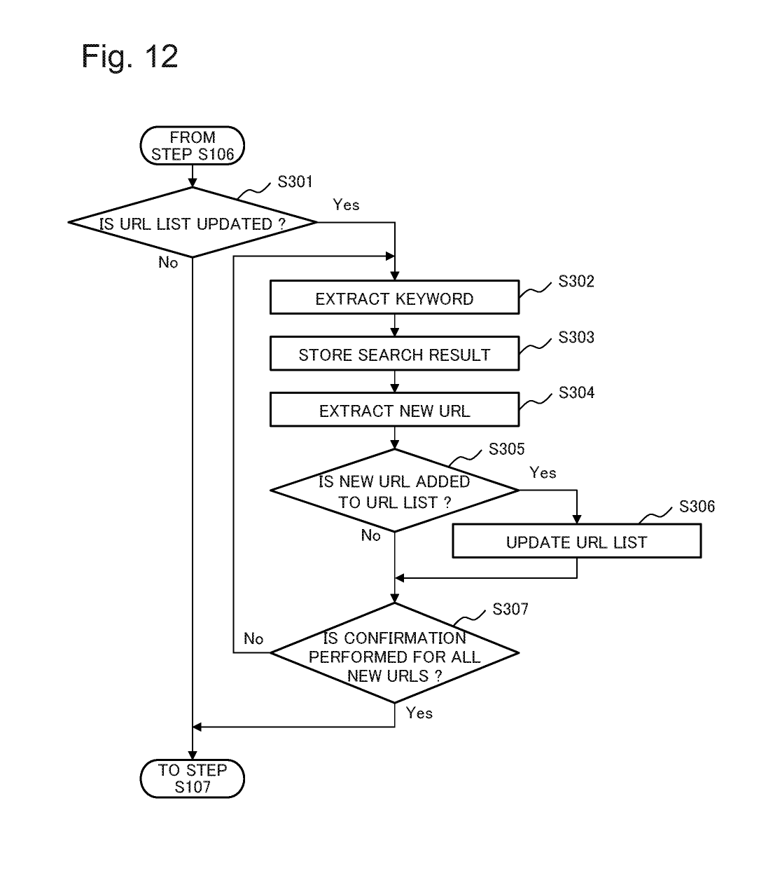

Next, the operation of the information extraction device 30 will be described by using FIG. 12. FIG. 12 is a flowchart showing the operation of the information extraction device 30.

The flowchart shown in FIG. 12 includes a process of updating (adding) the URL list. This is the only difference between the flowchart shown in FIG. 3 and the flowchart shown in FIG. 12.

In step S106 of FIG. 3, the accumulation control unit 36 extracts the structured information, stores it, and determines whether or not to update the URL list (step S301). When it is determined that the URL list is not updated, the process proceeds to step S107 and the accumulation control unit 36 performs the processes of step S107 and other steps in the flowchart shown in FIG. 3.

First, the Web search unit 39 extracts or selects the keyword in the extracted structured information (step S302). The Web search unit 39 searches for the keyword on the Internet and stores a search result (step S303).

Next, the Web search unit 39 extracts the URL that is not included in the existing URL list from the URLs extracted by the search and displays it to the user (step S304).

The Web search unit 39 makes the user determine whether or not to access the Web site with the displayed URL through the Web data acquisition unit 32 and acquire the Web data from now on (step S305). When it is determined that the Web site has to be added (Yes in step S305), the Web search unit 39 updates the URL list (step S306). When the confirmation is performed by the user for all the URLs (Yes in step S307), the process proceeds to step S107 and the Web search unit 39 performs the process in step S107.

The information extraction device 30 according to this exemplary embodiment has an effect described below.

Namely, the information extraction device 30 can increase the number of URLs of the Web servers that are the information acquisition sources.

This is because when the new content exists in the structured information that is the extracted data, the Web search unit 39 creates a list of the URLs of the Web pages including this content and when the new URL is included in the URL list, the Web search unit 39 updates the URL list held by the URL list storing unit 31.

### Fourth Exemplary Embodiment

Next, a fourth exemplary embodiment for practicing the present invention will be described in detail with reference to the drawing.

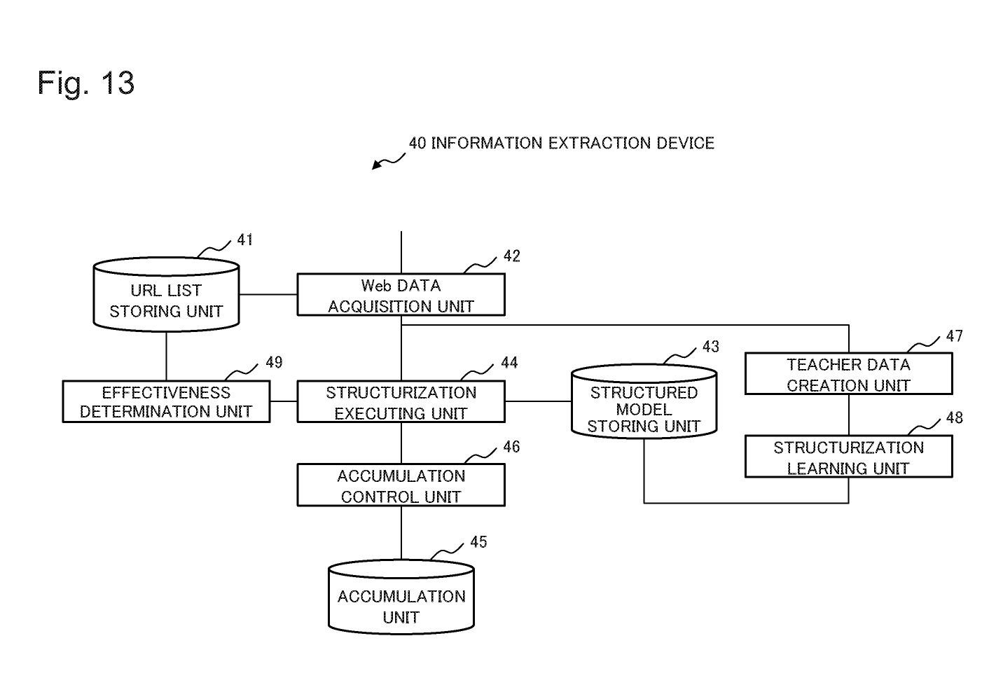

FIG. 13 is a block diagram showing an example of a configuration of an information extraction device 40 according to the fourth exemplary embodiment.

As shown in FIG. 13, the information extraction device 40 has a configuration in which an effectiveness determination unit 49 is added to the information extraction device 10 according to the first exemplary embodiment and can update the URL list of the Web servers that are information acquisition sources.

Further, a URL list storing unit 41, a Web data acquisition unit 42, a structured model storing unit 43, a structurization executing unit 44, an accumulation unit 45, an accumulation control unit 46, a teacher data creation unit 47, and a structurization learning unit 48 are similar to the URL list storing unit 11, the Web data acquisition unit 12, the structured model storing unit 13, the structurization executing unit 14, the accumulation unit 15, the accumulation control unit 16, the teacher data creation unit 17, and the structurization learning unit 18 according to the first exemplary embodiment, respectively and the description of the operation of each component will be omitted.

For example, in a case in which, although the structurization executing unit 44 performs the structurization process to extract the structured information, available data cannot be extracted, the effectiveness determination unit 49 decides that the URL of the acquisition source from which the Web data that is the processing object is acquired is not necessary and updates the URL list held by the URL list storing unit 41.

By performing such operation, the information extraction device 40 can delete the URL of the Web server that is an unneeded information source and extract the data at high speed.

Here, the effectiveness determination unit 49 is composed of hardware such as a logic circuit or the like. The effectiveness determination unit 49 may be realized by executing a program on a memory (not shown) by the processor of the information extraction device 40 that is a computer.

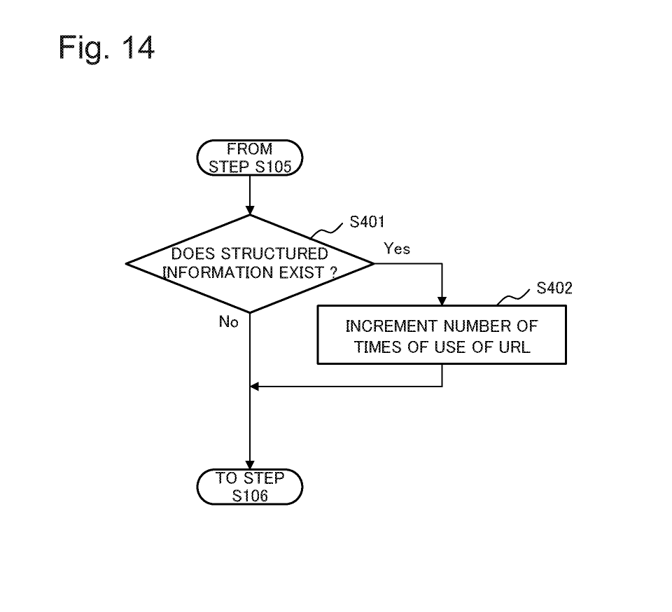

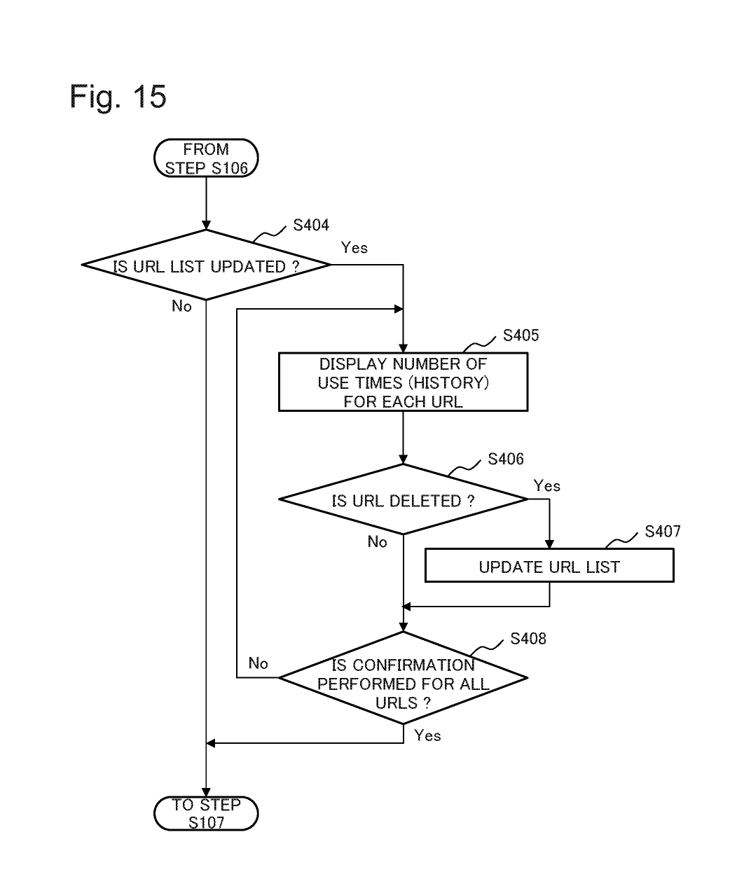

Next, the operation of the information extraction device 40 will be described by using FIG. 14 and FIG. 15.

FIG. 14 and FIG. 15 are flowcharts showing the operation of the information extraction device 40.

As shown in FIG. 14, in the processes of steps S105 to S106 shown in FIG. 3, the effectiveness determination unit 49 acquires data from a Web site with a certain URL. When the data to be extracted (the structured information) exists in the Web data of the Web site with the URL (Yes in step S401), this means that the URL is available. The effectiveness determination unit 49 stores the number of times as a history (step S402).

The flowchart shown in FIG. 15 includes a process of updating (deleting) the URL list. This is the only difference between the flowchart shown in FIG. 3 and the flowchart shown in FIG. 15.

The effectiveness determination unit 49 extracts the structured information in step S106, stores it, and determines whether or not to update the URL list (step S404). When it is determined that the URL list is not updated (No in step S404), the process proceeds to step S107 and the information extraction device 40 performs the processes of step S107 and other steps in the flowchart shown in FIG. 3.

The effectiveness determination unit 49 displays the number of use times (the history) for each URL (step S405).

The effectiveness determination unit 49 determines whether or not to acquire the Web data from the Web site with the URL from now on. When it is determined that the URL is not needed (Yes in step S406), the effectiveness determination unit 49 updates the URL list (step S407).

When the confirmation is performed by the effectiveness determination unit 49 for all the URLs (Yes in step S408), the process proceeds to step S107 and the effectiveness determination unit 49 performs the process in step S107.

The information extraction device 40 according to this exemplary embodiment has an effect described below.

Namely, the information extraction device 40 can extract the data at higher speed.

This is because the effectiveness determination unit 49 determines the effectiveness of the URL list and updates the URL list held by the URL list storing unit 41.

### Fifth Exemplary Embodiment

Next, a fifth exemplary embodiment for practicing the present invention will be described in detail with reference to the drawing.

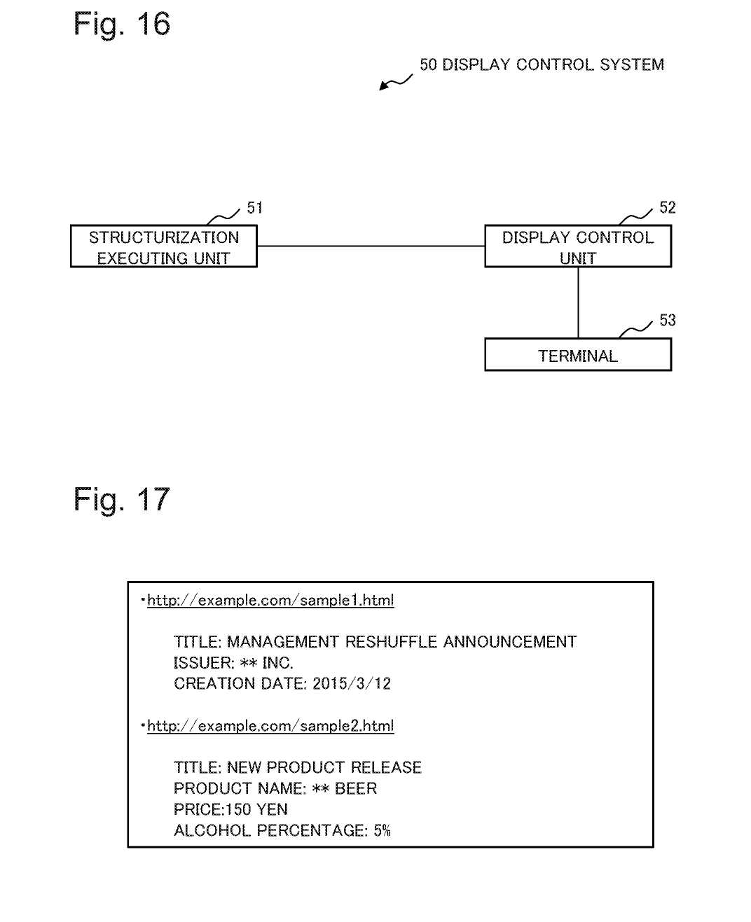

FIG. 16 is a block diagram showing an example of a configuration of a display control system 50 according to the fifth exemplary embodiment.

The display control system 50 includes a structurization executing unit 51, a display control unit 52, and a terminal 53. Each of these components may be composed of an information processing device including hardware circuit shown in FIG. 2.

The structurization executing unit 51 extracts the structured information that is information having a relationship from the document data that is the extraction object. The structurization executing unit 51 may include the components of the information extraction device 10 according to the first exemplary embodiment. Namely, the structurization executing unit 51 may include the URL list holding unit 11, the Web data acquisition unit 12, the structured model holding unit 13, the structurization executing unit 14, the accumulation unit 15, the accumulation control unit 16, the teacher data creation unit 17, and the structurization learning unit 18. The structurization executing unit 51 may include the component of the information extraction device 20 according to the second exemplary embodiment, the information extraction device 30 according to the third exemplary embodiment, or the information extraction device 40 according to the fourth exemplary embodiment.

The display control unit 52 makes the terminal 53 display the extraction result in order of certainty of the result obtained by extracting the structured information. Further, the display control unit 52 makes the terminal 53 associate the extraction result with the document data and display them. The display control unit 52 may calculate the certainty of the result obtained by extracting the structured information.

The terminal 53 displays the information according to the display control from the display control unit 52.

FIG. 17 is a figure showing an example of information displayed in the terminal 53. As shown in FIG. 17, the terminal 53 associates the document (for example, indication of the URL as shown in FIG. 17) with an extraction result extracted from the document and displays them.

The information extraction device 50 according to this exemplary embodiment has an effect described below.

Namely, the display control unit 52 can make the terminal display the extraction result in order of the certainty of the result obtained by extracting the structured information.

The reason is described below. Namely, the structurization executing unit 51 extracts the structured information that is information having the relationship from the document data that is the extraction object. Further, the display control unit 52 makes the terminal 53 display the extraction result in order of the certainty of the result obtained by extracting the structured information.

### Sixth Exemplary Embodiment

Next, a sixth exemplary embodiment for practicing the present invention will be described in detail with reference to the drawing.

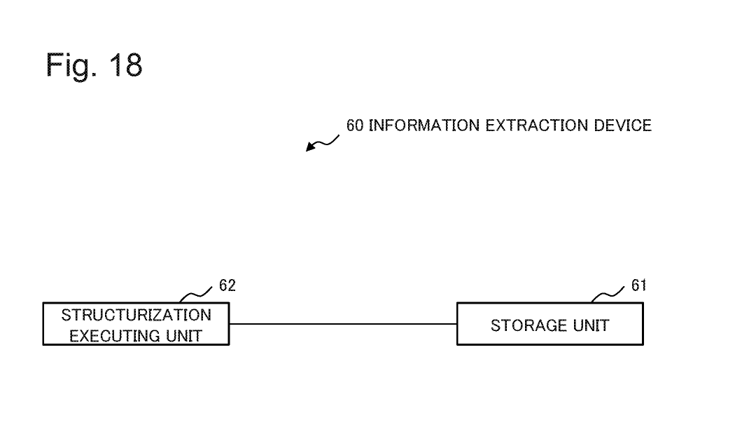

FIG. 18 is a block diagram showing an example of a configuration of an information extraction device 60 according to the sixth exemplary embodiment.

The information extraction device 60 includes a storage unit 61 and a structurization executing unit 62.

The storage unit 61 stores the structured model information that is a result obtained by learning a relationship between the type of the structured information that is the information having the relationship and the data content or the position of data of the structured information.

The structurization executing unit 62 extracts the structured information from the document data that is the extraction object on the basis of the structured model information.

The information extraction device 60 according to this exemplary embodiment has an effect described below.

Namely, the information extraction device 60 can efficiently extract the structured information from the document data.

The reason is described below. Namely, the storage unit 61 stores the structured model information that is the result obtained by learning the relationship between the type of the structured information that is the information having the relationship and the data content or the position of data of the structured information. Further, the structurization executing unit 62 extracts the structured information from the document data that is the extraction object on the basis of the structured model information.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. An information extraction device comprising:
a storage unit that stores structured model information that is a result obtained by learning a relationship between a type of structured information that is information having a relationship and a data content or a position of data of the structured information; and
a structurization executing unit that extracts the structured information from document data that is an extraction object based on the structured model information.

2. The information extraction device described in claim 1, further comprising:
a Web data acquisition unit that accesses a Web site by using a URL list and acquires Web data.

3. The information extraction device described in claim 2, further comprising:
a teacher data creation unit that creates teacher data based on Web data that is an object to be learned and acquired by the Web data acquisition unit.

4. The information extraction device described in claim 3, further comprising:
a structurization learning unit that reads teacher data created by the teacher data creation unit and learns a relationship between a type of the structured information and a displayed content or a display position of the structured information.

5. The information extraction device described in claim 1 in which the relationship between the type of the structured information and the data content or the position of data of the structured information is based on a character string describing the document data.

6. The information extraction device described in claim 5 in which the character string describing the document data is described by using a HTML (Hyper Text Markup Language).

7. The information extraction device described in claim 1 in which the structurization executing unit outputs a degree of certainty indicating a certainty of result obtained by extracting the structured information.

8. The information extraction device described in claim 1 in which the type of the structured information is information about a new product and the data content of the structured information includes a seller name, a sale date, or a product name.

9. The information extraction device described in claim 1, further comprising:
an accumulation data browsing unit that makes the structured information viewable to a user.

10. The information extraction device described in claim 1, further comprising:
a Web search unit that searches for a content on the Internet and creates a list of a Web page including the content when a new combination exists among the structured information and the content.

11. The information extraction device described in claim 2, further comprising:
an effectiveness determination unit that updates the URL list in a case available data cannot be extracted from a URL in the URL list.

12. An information extraction method comprising:
storing structured model information that is a result obtained by learning a relationship between a type of structured information that is information having a relationship and a data content or a position of data of the structured information; and
extracting the structured information from document data that is an extraction object on the basis of the structured model information.

13. A display control system comprising:
a structurization executing unit that extracts structured information that is information having a relationship from document data that is an extraction object; and
a display control unit that makes a terminal display an extraction result in order of a certainty of result obtained by extracting the structured information.

14. A display control system comprising:
a structurization executing unit that extracts structured information that is information having a relationship from document data that is an extraction object; and
a display control unit that makes a terminal associate an extraction result with the document data and display them.

15. The display control system described in claim 13 further including a terminal that displays information according to display control from the display control unit.
